(19) United States
(12) Patent Application Publication
(10) Pub. No.: US 2025/0027535 A1
(43) Pub. Date: Jan. 23, 2025

(54) LOW FRICTION SLIDE SYSTEM

(71) Applicant: Inter IKEA Systems B.V., LN DELFT (NL)

(72) Inventors: Håkan KÄLL, Älmhult (SE); Benny ANDERSSON, Älmhult (SE)

(73) Assignee: Inter IKEA Systems B.V., LN DELFT (NL)

(21) Appl. No.: 18/709,051

(22) PCT Filed: Nov. 9, 2022
(86) PCT No.: PCT/EP2022/081238

§ 371 Date: May 10, 2024

(30) Foreign Application Priority Data
Nov. 10, 2021 (SE) 2151376-7

(51) Int. Cl. F16C 29/02

(52) U.S. Cl. CPC F16C 29/02

(57) ABSTRACT

The present invention relates to a slide system (1) comprising a first slide member (10) having a slide surface (14) at least partly coated with a lipophilic composition coating (18) to provide a slide layer (19) with lowered friction, and a second slide member (20) arranged in sliding contact with the slide layer (19) at an interface to provide a slide system (1). The interface between the slide layer (19) and the second slide member (20) forms a plain bearing to allow for sliding movement of the second slide member (20) relative to the first slide member (10). At least the slide surface (14) of the first slide member (10) is made of a first plastic, and at least a part of said second slide member (20) being in sliding contact with the slide layer (19) is made of a second plastic. The first and the second plastics are different plastics. The invention further relates to a method for providing said slide system (1).

### FIELD OF THE INVENTION

The present invention relates to a slide system having a first slide member and a second slide member. Such sliding systems may for example be used in sliding door arrangements, extendable tables, kits for hanging curtains, and sliding drawer arrangements. The invention further relates to a method for forming said slide system.

### BACKGROUND

Linear plain furniture bearings in the form of slide systems are known in the art and have been used in several further constructions within the home, including extendable tables, chests of drawers, extendable sofa beds, and sliding doors etc. They are relatively simple, reliable constructions, and are easy to use. An exemplary slide system comprising a slide member is disclosed in e.g. the patent application WO2017/044032A1. The slide member in said document has a slide surface coated with a lacquer comprising a resin. The lacquer is in turn at least partly coated with a lipophilic composition coating to provide a slide layer with lowered friction. Such slide system has a very wide range of use, including heavy sliding doors, heavy drawers and the like.

However, in lighter furniture applications, such as lighter sliding drawers in bedside tables, smaller extendable tables, sliding doors in sideboards, or kits for hanging curtains, there is no need for such a robust slide system as disclosed in WO2017/044032A1. Therefore, it is of interest to provide a simpler, inexpensive, safe means form for providing a slide system with lowered friction for lighter sliding furniture applications. The lowered friction should preferably be in principle permanent and easy to manufacture. Further, the slide system should preferably be essentially maintenance-free.

### SUMMARY

Consequently, the present invention seeks to mitigate, alleviate, eliminate or circumvent one or more of the above identified deficiencies and disadvantages in the art singly or in any combination by providing in a first aspect a slide system comprising a first slide member having a slide surface at least partly coated with a lipophilic composition coating to provide a slide layer with lowered friction, and a second slide member arranged in sliding contact with the slide layer at an interface to provide a slide system. The interface between the slide layer and the second slide member forms a plain bearing to allow for sliding movement of the second slide member and the first slide member relative to each other. At least the slide surface of the first slide member is made of a first plastic, and at least a part of the second slide member being in sliding contact with the slide layer is made of a second plastic. The first and the second plastics are different plastics.

According to an embodiment, the first slide member is statically arranged whereas the second slide member is dynamically arranged, such as the second slide member being arranged to slide along the first slide member. However, also the first slide member may be dynamically arranged. According to an alternative embodiment, the second slide member is statically arranged, whereas the first slide member is dynamically arranged, such as the first slide member being arranged to slide along the second slide member.

This provides for a low friction slide system with efficient function in many applications, including furniture applications such as sliding doors, drawers, extendable bed frames and extendable tables, etc. The slide system disclosed herein is specifically suitable for furniture applications exposed to lighter loads, such as lighter sliding doors, extendable tables and drawers in e.g. a bedside table. Application of the lipophilic composition coating on the first slide member and the use of different plastics on the first and second slide members surprisingly reduced the long term dynamic friction after repeated use (up to about 80%) of the slide system. For instance, experiments have shown that the long term dynamic friction between a first and a second plastic slide member can be decreased from 14N to 3N upon addition of the lipophilic composition coating on the first slide member and the use of different plastics on the first and second slide members. Whereas the initial dynamic friction is quite high, the dynamic friction increases even further after a few cycles, without application of the lipophilic composition coating. On the contrary, if a lipophilic composition coating is applied, the dynamic friction remains low even after repeated use.

The slide system is further inexpensive and easy to manufacture, since plastic parts may be formed by e.g. extrusion or injection moulding. For instance, the first slide member can be formed by extrusion while the second slide member may be made using injection moulding. The extrusion process is fast and efficient when manufacturing continuous shapes with uniform cross-section along its longitudinal extension, such as the first slide member, in varying lengths. Hence, manufacturing with extrusion can easily be adapted depending on which length or shape one wish to obtain for the first slide member. Since extrusion can be performed as a continuous process, the first slide member can be produced in high volumes quickly, with a low amount of waste material. The second slide member can easily be formed using injection moulding, a manufacturing process which enables the formation of almost any type of shape, even complex structures, with very high precision and replicability. It is also a very efficient process, where a large number of second slide members may be formed quickly.

Having slide members made of plastics also provide parts of the slide system being somewhat flexible, which may be advantages in tight spaces during for instance mounting of the slide system. Furthermore, it has surprisingly been found that the decreased friction effect was not only temporary, but also seemingly permanent or at least long-lasting. There is thus no need to replenish the lubricant in the form of the lipophilic composition coating.

Moreover, plain bearings in slide systems used in furniture applications exposed to lighter loads do not normally comprise an interface comprising two plastic surfaces in contact with each other. Hence, it is surprising that the present invention providing a slide surface arranged on a first slide member made of a first plastic in sliding contact with a part of a second slide member made of a second plastic provides an advantageous slide system, where the need of a metal support or the like can be dispensed with. In addition, since both surfaces of the interface where the sliding contacts takes place are made of plastics rather than a metal surface, no additional lacquer coating of the surface is required.

The first and the second plastics are different plastics. Thus, the plastics not only are different grades of plastics (e.g. PET with different intrinsic viscosity), but also at least plastics of different sub-types of plastics (e.g. PA 6 and PA 66, or PET and PBT), or preferably different types of plastics (e.g. polyacetal and polyamide), i.e. plastics comprising different types of polymers. According to an embodiment, the first and the second plastics are different types of plastics. Thus, the first plastic may comprise a first type of polymer, e.g. a polyoxymethylene (POM), whereas the second plastic may comprise another type of polymer, e.g. a polyamide (PA), such as PA6. In different types of polymers, the linkage between the monomers typically differs (e.g. amide coupling and acetal coupling, respectively), and/or the functional groups attached to the polymer chain differ (e.g. amide group and methyl group, respectively).

The first plastic and/or the second plastic are typically a thermoplastic.

In one embodiment, the first and the second plastic are polymers selected from the group of polymers consisting of polyoxymethylenes (POM), polymethyl methacrylate (PMMA), polycarbonate (PC), polypropylene (PP), polypropylene copolymers (PPCO), polyesters (e.g. thermoplastic polyesters, such as polyethylene terephthalate (PET), polytrimethylene terephthalate (PTT), polybutylene terephthalate (PBT), and polylactic acid (PLA), as well as bio-based thermoplastic polyesters, such as polyhydroxyalkanoates (PHA), polyhydroxybutyrate (PHB), and polyethylene furanoate (PEF)), polyamides (PA), such as polyamide 6 (PA6), polyvinyl chloride (PVC), polyphenylene sulfide (PPS), polyaryletherketone (PAEK; e.g. Polyether ether ketone (PEEK)), and Polytetrafluoroethylene (PTFE). As already stated, the first and the second plastics are different plastics. Preferably, first and the second plastics are different types of plastics, such as POM and PA.

In another embodiment, the first slide member is made of PA, PC, PPCO, or PMMA, and the second slide member is made of POM or PA; or the second slide member is made of PA, PC, PPCO, or PMMA, and the first slide member is made of POM or PA. The first slide member and the second slide member are made of different plastics; preferably different types of plastics. In a preferred embodiment, one of the slide members is made of POM and the other slide member is made of PA, such as PA6, or PC, most preferred the second slide member is made of POM, and the first slide member is made of PA or PC.

According to an embodiment, the second slide member is made of POM and the first slide member is made of PA, such as PA6. Preferably, the first slide member is made of PA6. Such a combination provides a low dynamic friction.

According to another embodiment, the second slide member is made of POM and the first slide member is made of PET. Also this combination, was found to provide low dynamic friction.

The first slide member may be a slide bar forming a linear slide profile. Such a slide bar is typically statically arranged. Preferably, the slide bar is a plastic slide bar made of the first plastic, such as PA. In such case, the slide bar forming the linear slide profile may be provided with a plastic profile surface arranged on or in a support structure. When arranged in a support structure, the first slide member may be an insert, such as a U-profile, arranged in a recess of the support structure, such as in a rim for a table surface of an extendable table. Further, also the floor portion of e.g. a wardrobe or the bottom portion of e.g. a kitchen fixture may serve as the support structure to accept an insert. In one embodiment, the first slide member is arranged on a support structure with a snap-fit engagement.

According to an embodiment, the slide bar is a plastic slide bar made of the first plastic. The plastic slide bar may have the form of an insert to be arranged in a recess of a support structure.

However, a plastic profile may also form the linear slide profile on its own without any need for a support structure. According to an alternative embodiment, wherein the second slide member is statically arranged, it may be a slide bar forming a linear slide profile, such as a plastic slide bar made of the second plastic.

Further, the first slide member, such as in the form of a slide bar, may be monolithic. The slide bar may be extruded or injection moulded in one piece, i.e. a monolithic slide member. Injection moulding is a simple and commonly used method for forming plastic articles. Hence, the manufacturing of such a slide bar with injection moulding is quick, easy and cheap. Extruding the slide bar is also an efficient manner of forming a slide bar, in particular when forming a long, such as longer than 50 cm, slide bar having a constant profile along its entire length.

Similarly, the second slide member may be moulded, e.g. injection moulded, in one piece. Thus, the second slide member may be monolithic. As already mentioned, injection moulding is a simple and commonly used method for forming plastic articles. Hence, the manufacturing of such a slide member with injection moulding is quick, easy and cheap.

Contrary to the teaching of the prior art, e.g. WO 2017/044032A1, the lipophilic composition coating of the present slide system is coated directly on the slide surface of the first slide member, not on an intermediate lacquer. As the slide surface is made of a first plastic, thereby dispensing with the need to lacquer the first slide member in order to provide it with low friction, the slide surface of the first slide member is typically at least 150 μm thick to provide the first slide member with structural integrity. The slide surface may be at least 250 μm, at least 500 μm, at least 750 μm, or at least 1 mm thick. The smallest dimension of the cross section of the slide member perpendicular to the slide surface may thus be at least 150 μm, such as at least 250 μm, at least 500 μm, at least 750 μm, or at least 1 mm. Further, the thickness of the first slide member may vary over its cross-section. The thickness of the first slide member may be at least 150 μm, such as at least 250 μm, at least 500 μm, at least 750 μm, or at least 1 mm.

Hence, the first slide member and the second slide member are typically non-lacquered, or have at least a non-lacquered surface at the interface arranged to form the sliding contact between the slide layer of the first slide member and the second slide member.

In one embodiment, a lipophilic composition may be applied to the second slide member, and transferred, at least partly, to the first slide member from said second slide member when the first and second slide members are brought into contact with each other. Preferably, in such case, the lipophilic composition is applied onto the second slide member at the interface arranged to be in sliding contact with the first slide member.

In one embodiment, the part of the second slide member being in contact with the slide layer of the slide surface is configured as having at least one blade extending in a sliding direction. In such case, the slide layer may be present at a track, such as a groove or a ridge, extending along the sliding direction. The track may serve to guide the at least one blade in sliding along the slide bar. Further, the second slide member may be provided with more than one blade, such as 2, 3, 4 or 5 blades, being arranged in contact with the slide layer. According to one embodiment, each blade has a length, as seen along the sliding direction, of maximum 15 mm, such as maximum 10 mm or even maximum 5 mm. According to one embodiment, each blade has a length of at least 1 mm, such as at least 2 mm. Especially if the slide layer is present at a ridge, it may be preferred to provide the second slide member may be with more than one blade.

In another embodiment, the second slide member comprises at least one individual contact point in contact with the first slide member at the interface between the first slide member and the second slide member. The contact area of each individual contact point is preferably less than 3 mm², more preferably less than 1.5 mm², and most preferably less than 0.75 mm². Preferably, the contact pressure in said at least one contact point is at least 4 N/mm², preferably at least 8 N/mm², and more preferably at least 12 N/mm², and preferably the contact pressure is lower than the strain at yield of the material of the second slide member at the contact point. Normally, it is preferable to provide a larger surface area of the contact point, in order to distribute the load as much as possible, especially in the case of interfaces between two plastic surfaces being slightly soft (as compared to e.g. a metal). Hence, it is surprising that the contact area of each individual contact point in the slide system disclosed herein is preferably less than 3 mm².

In a further embodiment, the first slide member and the second slide member of the slide system are provided in a sliding application of a furniture in which the slide system is carrying a load of less than 35 kg, such as less than 20 kg, such as less than 15 kg, or even less than 10 kg. The slide system may carry a load of 15 to 20 kg.

The first slide member and the second slide member of the slide system may be provided in an extendable table sliding system, a drawer sliding system, a sliding door system, a sofa bed, or a furniture rotary system, such as a roller bearing system. According to an embodiment, the first slide member and the second slide member of the slide system is provided in a drawer sliding system, an extendable table sliding system, or a sliding door system.

As already mention, the second slide member may be statically arranged, whereas the first slide member is dynamically arranged according to an alternative embodiment. In such an embodiment, the second slide member may be a linear slide profile provided with at least one blade. The first slide member with the slide layer may then be arranged to slide along the longitudinal extension of the second slide member.

In one embodiment, the lipophilic composition coating comprises compounds comprising C6 to C40, such as C8 to C30, or even C10 to C24, non-aromatic hydrocarbyl groups, such as alkenyl groups and/or alkyl groups, e.g. alkyl groups. The lipophilic composition coating may comprise at least 25 wt. %, such as at least 50 wt. %, at least 75 wt. %, or at least 90 wt. %, of compounds comprising C6 to C40, such as C8 to C30, alkyl groups. Typically, the lipophilic composition coating comprises non-aromatic hydrocarbons, such as alkenes and/or alkanes, e.g. alkanes, and/or triglycerides and/or fatty acids, e.g. triglycerides. According to an embodiment, the lipophilic composition coating comprises a mixture of alkanes and triglycerides. Whereas the triglycerides provide even lower dynamic friction, the alkanes improve the long term stability of the lipophilic composition.

The lipophilic composition coating may comprise at least 25 wt. %, such as at least 50 wt. %, C6 to C40, such as C8 to C30, non-aromatic hydrocarbons, such as alkenes and/or alkanes, e.g. alkanes.

As already mentioned, the lipophilic composition may further comprise triglycerides and/or fatty acids, such as triglycerides. Preferably said triglycerides, if present, are composed of saturated fatty acids residues. Similarly, said fatty acids, if present, are saturated fatty acids. Preferably the lipophilic composition coating comprises 1 to 40 wt. % triglycerides and/or fatty acids. In such case, preferably the triglycerides, if present, are to at least 90% composed of fatty acids with C6 to C40, such as C8 to C30, alkyl groups. Preferably said fatty acids, if present, having C6 to C40, such as C8 to C30, alkyl groups. Alternatively, the lipophilic composition coating preferably comprises at least 25 wt. %, such as at least 50 wt. %, of triglycerides and/or fatty acids, preferably said triglycerides, if present, to at least 90% being composed of fatty acids with C6 to C40, such as C8 to C30, alkyl groups, and preferably said fatty acids, if present, having C8 to C40, such as C8 to C30, alkyl groups. Preferably, the lipophilic composition is not only composed of fatty acids.

In another embodiment, the lipophilic composition coating comprises a C10 to C28 alkane and a tri-glyceride, and the viscosity, according to ISO 3104:1994/C or 1:1997, of the lipophilic composition coating at 40° C. is 20 to 80 mm²/s.

The lipophilic composition coating may further comprise an anti-oxidant. Preferably the lipophilic composition coating comprises up to 5 wt. % of the anti-oxidant, such as up to 2.5 wt. % of the anti-oxidant, such as 0.1 to 1 wt. % of the anti-oxidant. Preferably the anti-oxidant has an E-number (accepted as food-ingredient), and preferably the anti-oxidant has a log P (n-octanol/water) value of at least 1 at 25° C.

In one embodiment, the anti-oxidant is selected from the group consisting of tocopherols, e.g. (±)-α-tocopherol, and sterically hindered phenols, e.g. dibutylhydroxy-toluene or butylated hydroxyanisole.

The lipophilic composition coating may comprise a mixture of at least two different tri-glycerides, and/or a mixture of at least two different C10 to C28 alkanes. Preferably, the lipophilic composition coating comprises a mixture of at least two different tri-glycerides and at least two different C10 to C28 alkanes.

In another embodiment, the lipophilic composition coating comprises at least 50 wt. % of a C10 to C28 alkane, or a mixture of C10 to C28 alkanes, and 1 to 50 wt. % of a tri-glyceride, or a mixture of tri-glycerides. In such case, the lipophilic composition coating may comprise at least 60 wt. % of a C10 to C28 alkane, or a mixture of C10 to C28 alkanes, and 5 to 40 wt. % of a tri-glyceride, or a mixture of tri-glycerides. Further, in such case, the lipophilic composition coating may comprise at least 70 wt. % of a C10 to C28 alkane, or a mixture of C10 to C28 alkanes, and 10 to 30 wt. % of a tri-glyceride, or a mixture of tri-glycerides.

Typically, the lipophilic composition coating comprises less than 5 wt. % aromatics. Preferably, the lipophilic composition coating comprises less than 2.5 wt. % aromatics, even more preferably less than 1.0 wt. % aromatics.

In a further embodiment, the lipophilic composition coating has a Total Iodine Value according to ASTM D1541-97 of less than 10; preferably less than 5. As recognized by the skilled per, the Total Iodine Value is representative for the amount of unsaturation in a composition.

In a second aspect, there is provided a method for providing a slide system comprising the steps of providing a member having a slide surface, wherein at least the slide surface is made of a first plastic, and coating at least part of the slide surface with a lipophilic composition coating to provide a first slide member having a slide layer with lowered friction. The method further comprises providing a second slide member, wherein at least a part of said second slide member configured to be in sliding contact with the slide layer is made of a second plastic, which is different from the first plastic, and arranging the first slide member and second slide member such that an interface between the slide layer and the second slide member forms a plain bearing to allow for sliding movement of the second slide member and the first slide member relative to each other. Aspects and preferred features in relation to such a method have already been described herein above in relation to the slide system. As appreciated by the skilled person, they are equally applicable in relation to the method.

Further advantageous features of the invention are elaborated in embodiments disclosed herein. In addition, advantageous features of the invention are defined in the dependent claims.

### BRIEF DESCRIPTION OF THE DRAWINGS

The above and other aspects, features and advantages of which the invention is capable of will be apparent and elucidated from the following description of the present invention, reference being made to the accompanying drawings, in which

FIG. 1 depicts a cross section of a slide system according to a first embodiment;

FIG. 2 depicts details of the slide member in FIG. 1;

FIG. 3 depicts a slide system according to a second embodiment;

FIG. 4 is an isometric view of the slide member of FIG. 3;

FIG. 5a is an isometric view of an exemplary extendable table comprising a slide system according to a third embodiment of the present invention;

FIG. 5b is an isometric view of a part of the slide system arranged in the extendable table in FIG. 5a;

FIG. 5c is an isometric view of a first slide member in the form of an insert of the slide system shown in FIGS. 5a and 5b;

FIG. 5d is an isometric view of an exemplary slide member of the slide system shown in FIG. 5a;

FIG. 6a shows an embodiment of the slide system arranged in a sliding door of a closet;

FIG. 6b is a cross-section of the slide system shown in FIG. 6a;

FIG. 7a-7d are isometric views of parts of a slide system according to the present invention configured to be arranged in e.g. a drawer slide system, whereas FIG. 7e is a cross-section of an assembled slide system according to the present invention configured to be arranged in e.g. a drawer slide system;

FIG. 8 depicts a slide system according to a further embodiment of the present invention; and

FIG. 9 depicts a schematic setup of an experimental procedure.

### DETAILED EMBODIMENTS

The present inventors have surprisingly found that a slide system 1 with very low slide friction can be obtained by using a first slide member 10 provided with a slide surface 14 at least partly coated with a lipophilic composition coating 18 to provide a slide layer 19, and a second slide member 20 arranged in sliding contact with the slide layer 19 at an interface. The interface between the slide layer 19 and the second slide member 20 forms a plain bearing allowing sliding movement of the second slide member 20 and the first slide member 10 in relation to each other. At least the slide surface 14 of the first slide member 10 is made of a first plastic, and at least a part of the second slide member 20 in sliding contact with the slide layer 19 is made of a second plastic, which is a different plastic from the first plastic.

Without being bound by any theory, it is believed that the use of first and seconds plastics being different from each other, lowers the attraction forces between the slide layer 19 and the second slide member 20, thus resulting in a lowered sliding friction there between. In addition, the lipophilic composition coating acts as a lubricating coating, and may comprise for example sebum (natural or artificial), coconut oil, or liquid paraffin, and provides a slide layer with extremely low dynamic friction (sliding resistance). The application of the lipophilic composition coating and the use of different plastics for the first and second slide members 10, 20 reduce the dynamic friction with as much as about 75-80% (see for instance Example 2 and 3 presented in the Experimental section below). Further, and even more surprisingly, the effect is not temporarily, but seemingly permanent or at least long-lasting. The need to replenish the lubricant may hence be dispensed with.

In experiments employing a slide system according to the present invention, where a slide surface of a first slide member has been coated with a lipophilic composition coating, the friction remained nearly the same after more than 50,000 test cycles. So many cycles by far exceed the expected number on lifetime cycles in most furniture applications. The experiments are described in more detail in the section Experiments below.

Further, very low amounts of the lipophilic composition coating are needed to provide lowered friction. Thus, contamination of the lubricating coating does not pose any pronounced problem, as the coating, due to the very low amount present, does not have substantial adhesive properties. This is in contrast to the normal use of lubricants in plain bearings. Further, exposure to contaminations, e.g. dust etc., has been shown not to affect the lowered friction. Neither is the lubricating coating sensitive to washing. Wiping the slide member, e.g. the first slide member 10, with a dry and/or wet cloth, does not affect the lowered friction. These properties make the slide member, e.g. the slide bar 10, very useful for use in systems for sliding wardrobe doors, extendable tables, drawers of chests of drawers, hanging curtains, and similar applications.

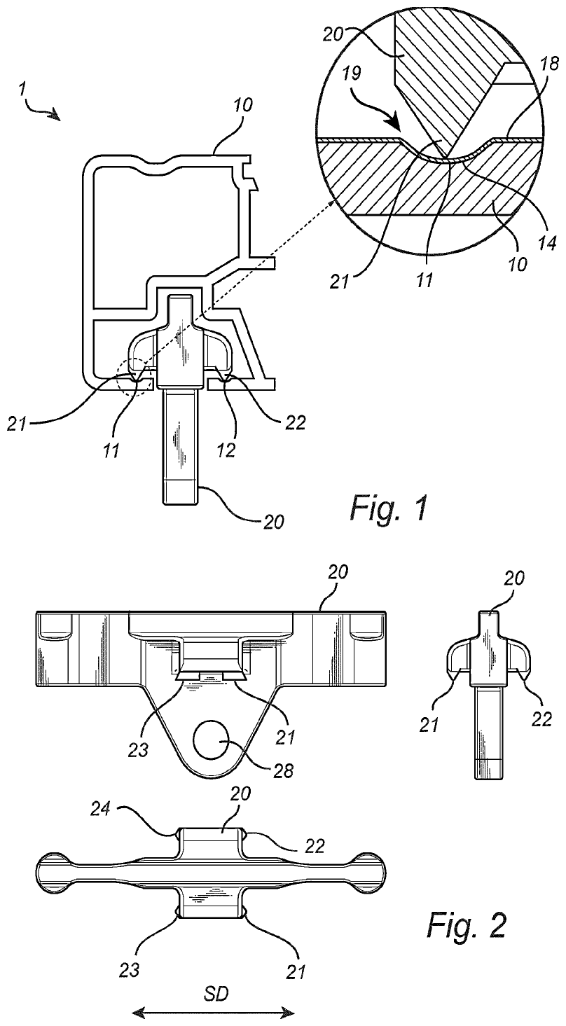

According to an embodiment, the slide system 1 comprises the first slide member 10 and the second slide member 20, as depicted in FIGS. 1 to 6. The first slide member 10 has a slide surface 14, onto which a lipophilic composition coating 18 has been provided. The slide surface 14 with the lipophilic composition coating 18 forms a slide layer 19 on the first slide member 10. The second slide member 20 is arranged in contact with the slide layer 19. The lipophilic composition coating 18 may be present in a groove 11 formed in the first slide member 10 to allow for reduced friction between one or more blades 21, 23 of the second slide member 20 and the slide layer 19 provided on said groove 11 of the first slide member 10.

As shown in an enlarged view of FIG. 1, the interface between the slide layer 19 and a sharp edge in the form of the blade 21 on the second slide member 20 forms a plain bearing which allows the first and second slide members 10, 20 to move relative to each other. The blade 21 is in contact with the slide layer 19 in the groove 11. The groove 11 may form a track extending in a sliding direction SD (shown in FIG. 2). The contact between the blade 21 and the slide layer 19 is shown in more detail in an enlarged portion of the slide system 1 in FIG. 1. Preferably, the second slide member 20 is movable in relation to the first slide member 10, being in a fixed position.

Further, as shown to the left in FIG. 1 the second slide member 20 may be provided with two parallel, displaced blades 21, 22 in order to prevent rotation along the sliding axis SD. Further, the first slide member 10 may be provided with two parallel grooves 11, 12 arranged along each side of its longitudinal sliding direction SD. The parallel grooves 11, 12 will support and guide the two parallel blades 21, 22 of the second slide member 20.

Alternatively, the second slide member 20 may comprise at least one blade 21 arranged in contact with a sliding layer 19 present on a flat slide surface 14 of the first slide member 10 (not shown). Hence, in such case, the at least one blade 21 slides along the flat surface of the first slide member 10.

The slide surface 14 of the first slide member 10 is made of a first plastic, while the blade 21 of the second slide member 20 is made of a second plastic, being different from the first plastic. Optionally, the entire first slide member 10 is made from the first plastic and/or the entire second slide member 20 is made from the second plastics.

The first slide member 10 may be a slide bar 10 forming a linear slide profile. Alternatively, the first slide member 10 forming the linear slide profile is provided with a plastic profile surface arranged on a support structure (not shown). Said support structure may be made from a non-plastic material, such as metal or wood, or another type of plastic material than the plastic profile. In one embodiment, the first slide member 10 is arranged on a support structure, preferably with a snap-fit engagement.

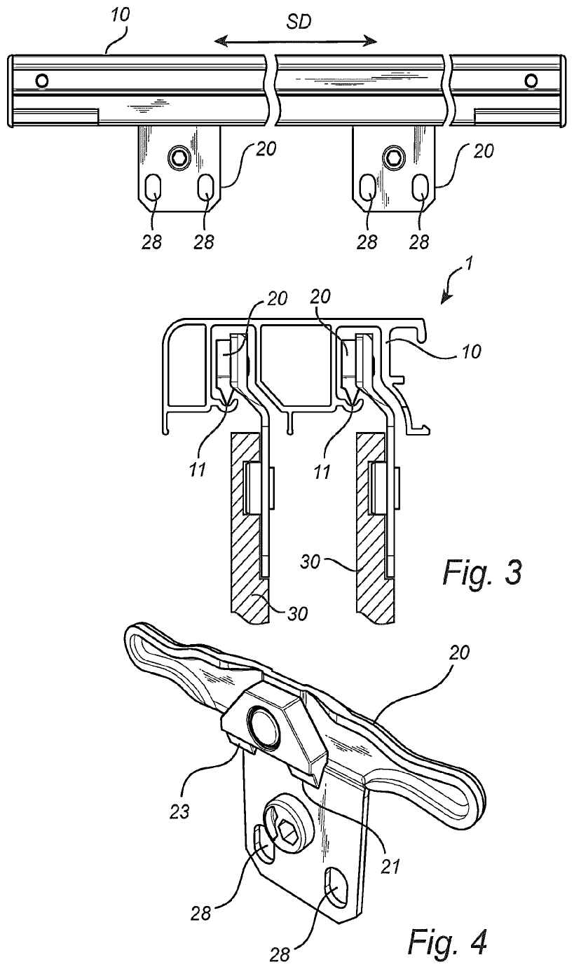

FIG. 2 shows views of the second slide member 20 shown in FIG. 1. The second slide member 20 may be provided with two, or more, blades 21, 23, arranged along the same sliding direction SD running in the same groove 11. Further, the second slide member 20 may be provided with displaced blades 21, 22 adapted for running in two parallel grooves 11, 12. Thus, as shown in the bottom drawing of FIG. 2, the second slide member 20 comprises four blades, 21, 22, 23, 24, where the blades 21, 22 and the blades 23, 24 are displaced and adapted to run in two parallel grooves 11, 12. The blades 22, 24 and the blades 21, 23 are arranged in parallel, aligned along the same sliding direction SD and adapted to run in the same groove 11 or groove 12, respectively. However, the second slide member 20 may be provided with fewer or more parallel or displaced blades. Further, as shown in FIG. 2, the second slide member 20 may also be provided with fastening arrangements 28, e.g. holes, pins, etc., for connecting the sliding member 20 further to a furniture part, such as a sliding door 30 (of the type shown in FIG. 3).

As shown in FIG. 3, a slide system 1 according to another embodiment may be used to support a sliding door 30 connected to the second slide member 20. Thus, the second slide member 20 may be provided with fastening arrangements 28, e.g. holes, pins, etc., for connecting the sliding member 20 to the sliding door 30. Further, first slide members 10 with two parallel grooves 11, 12, supporting two separate slide members 20, are preferred in a slide system 1 arranged to support more than one sliding door 30 (cf. FIG. 3) as only one first slide member 10 is then required. As shown in FIG. 4 the second slide member 20 has totally two blades 21, 23, instead of four as in the embodiment of FIG. 2.

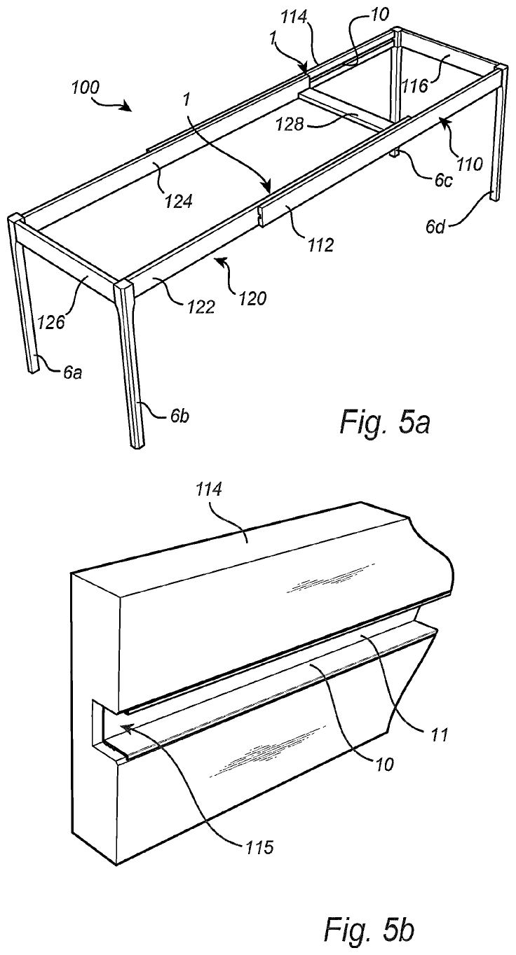

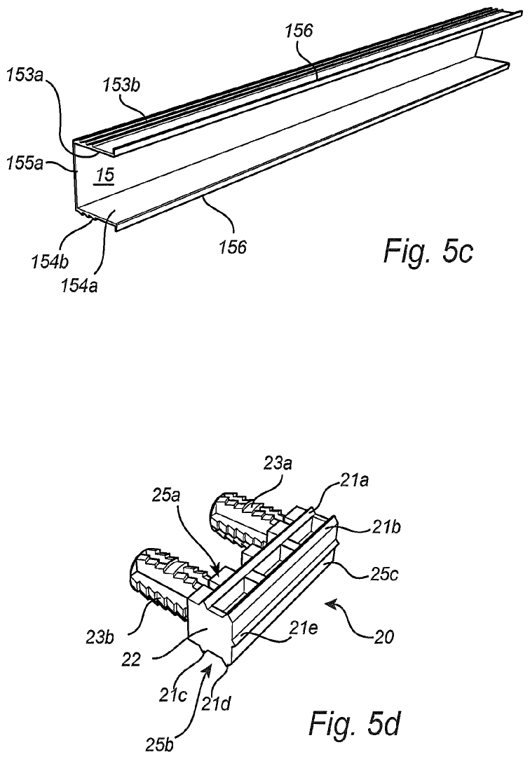

FIG. 5a shows an example of the slide system 1 according to the present invention arranged in an exemplary extendable table 100. The table 100 has a fixed part 110, a moveable part 120, and four legs 6a, 6b, 6c, 6d. The fixed part 110 forms a rim for the table surface (not shown). Further, the fixed part 110 comprises two parallel members 112, 114 being interconnected at some position along their respective length, such as at one of their respective ends, by a traverse beam 116. The traverse beam 116 is arranged perpendicularly to the two parallel members 112, 114. The parallel members 112, 114 are preferably of the same length which may be selected to correspond to the length of the table surface 2, or slightly less than that. Each parallel member 112, 114 forms a first slide member 10 of a respective slide system 1 as will be described in more detail below.

The moveable part 120 comprises two parallel members 122, 124 being inter-connected at some position along their respective length, such as at one of their respective ends, by a traverse beam 126. The traverse beam 126 is preferably arranged perpendicularly to the two parallel members 122, 124. Optionally an additional cross beam 128 is provided at the opposite ends of the parallel members 122, 124. Each parallel member 122, 124 forms a second slide member 20 of the respective slide systems 1 as will be described in more detail with reference to FIGS. 5b and 5c. FIG. 5b shows the parallel member 114 comprising a longitudinal recess 115, comprising a first slide member 10. The first slide member 10 has the same properties as described above with reference to FIG. 1 in which a second slide member 20 may be arranged in contact with the first slide member 10. The first slide member 10 is in FIGS. 5b and 5c provided as an insert 15, which is shown in more detail in FIG. 5c. The first slide member 10 in the form of an insert 15 shown in FIGS. 5b and 5c preferably extends along the entire length of the recess 115, or close to the entire length of the recess 115. The insert 15 is made of a first plastic material, such as PA (e.g. PA6), and has an upper inner surface 153a, a lower inner surface 154a, and a distal inner surface 155a.

The upper and lower inner surfaces 153a, 154a are preferably extending in parallel with each other whereby the distal inner surface 155a extends perpendicularly to the upper and lower surfaces 153a, 154a. The upper and lower surfaces 153a, 154a thus extend in the horizontal plane, while the distal surface 155a extends in the vertical plane. All surfaces 153a, 154a, 155a are provided with superior low friction properties according to the principles described above, and these together form, in this embodiment, the first slide member 10 provided with a slide surface 14 of the slide system 1. The insert 15 is attached to the recess 115 e.g. by an adhesive, by friction or similar. In particular, the insert 15 may comprise ridges 153b on its horizontal outer faces, thereby providing for friction engagement to the recess 115. The insert 15 could be made by extruding a plastic material, such as PA (e.g. PA6). The parallel beams 122, 124 are each provided with a second slide member 20 configured to slide along the first slide member 10 of the parallel beams 112, 114. The insert 15 shown in FIGS. 5b and 5c may also be present in other furniture, such as in a cupboard comprising drawers.

FIG. 5d shows an exemplary second slide member 20 to be used in the slide system 1 of FIG. 5a. The second slide member 20 in FIG. 5d has a main body 22, two dowels 23a, 23b and five blades 21a-e, each blade being configured to contact the sliding surface 19 of the first slide member 10 being the insert 15. An upper surface 25a of the main body 22 is provided with two parallel blades 21a-b, a lower surface 25b of the main body 22 is provided with two parallel blades 21c-d, and a distal surface 25c of the main body 22 is provided with one blade 21e. Each blade 21a-e may extend along the entire length of the main body 22, as illustrated in FIG. 5d, but it is also possible to divide each blade 21a-e into several shorter segments. The upper and lower blades 21a-d ensure the correct vertical position of the second slide member 20 within the insert 15, while the distal blade 21e provides alignment in the horizontal plane relative the insert 15. The second slide member 20 shown in FIG. 5d slides along the first slide member 10 shown in FIG. 5c in the same manner as described for the slide system 1 of FIG. 1. The second slide member 20 could be made by injection moulding a plastic material, such as POM, which is different from that of the insert 15. Optionally, the first slide member 10 further comprise grooves 11 adapted to receive the blades 21a-e of the second slide member 20.

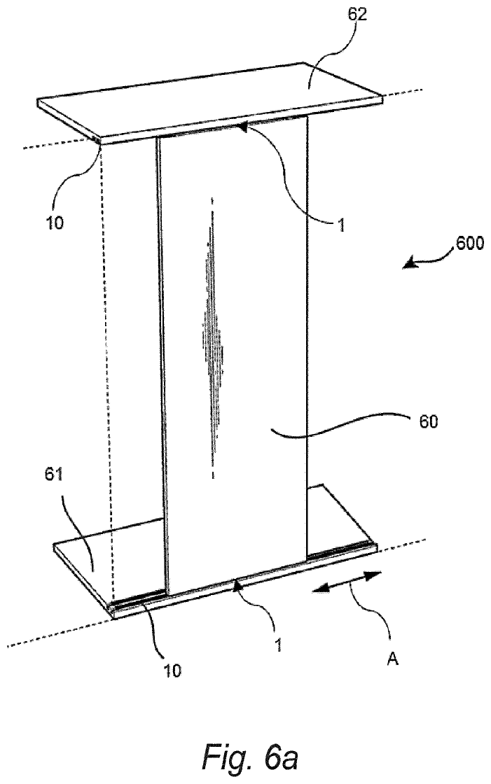

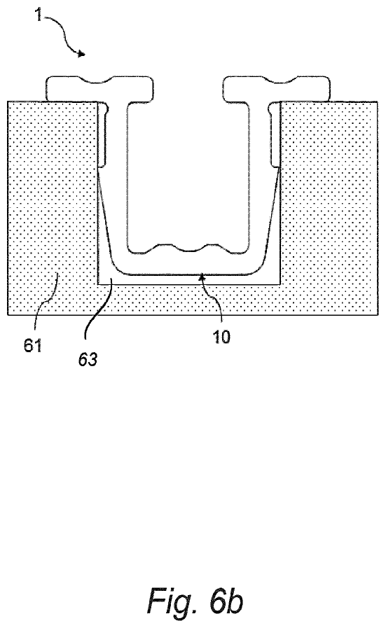

FIG. 6a shows a sliding door arrangement 600 in which a sliding door 60 is arranged to slide along an axis A. The sliding door arrangement 600 further comprises a floor portion 61 and a top portion 62. A slide system 1 according to the present invention is comprised in the sliding door arrangement 600. Each one of the portions 61, 62 acts as a support structure and is provided with a first slide member 10. A second slide member 20 (not shown in FIG. 6a) is arranged on the top and bottom edges of the sliding door 60. A cross-section of the arrangement of the first slide member 10 in the floor portion 61 is shown in FIG. 6b. The first slide member 10 has the form of an insert having a U-shaped cross-section, which can beneficially be manufactured using for instance extrusion, as described above. The U-shaped first slide member 10 is arranged in a recess 63 of the floor portion 61.

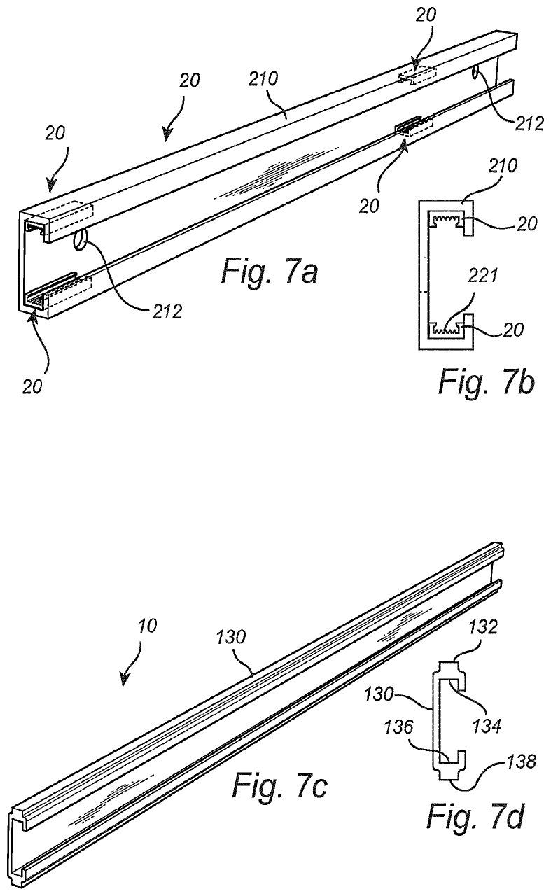

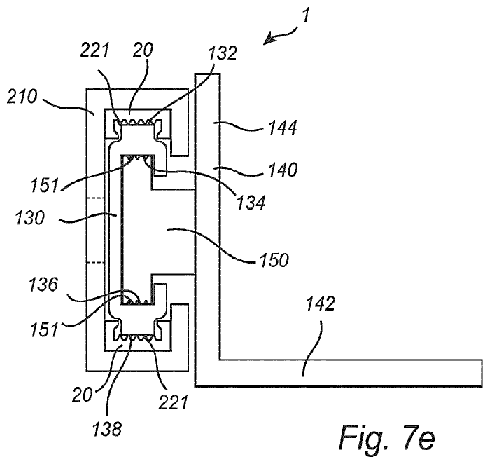

Now turning to FIGS. 7a-b, a slide system 1 configured to be arranged in a drawer system is shown. The slide system 1 comprises a first slide member 10 (shown in FIGS. 6c and 6d) and a second slide member 20 (shown in FIGS. 6a and 6b).

FIG. 7a show a first guiding rail 210 provided with four separate second slide members 20. A transversal cross-section of the second slide member 20 arranged on the guiding rail 210 is best shown in FIG. 7b. The first guiding rail 210 is provided with securing means 212, here in the form of two spaced apart through holes, for securely attaching the guiding rail 210 to an inner wall of a fixed frame structure, such as to a cabinet of a chest of drawers. Horizontal mounting of the first guiding rail 210 is preferred. The first guiding rail 210 has a C-shape, as shown in FIG. 7b, and is in FIG. 7a provided with two sets of second slide members 20 that are all mounted inside the C-shape of the guiding rail 210. Hence, in this embodiment the guiding rail 210, which for example could be made from wood, plastic or metal, serves as a support structure for the second slide members 20. The second slide members 20 may also be referred to as a plastic profile surface.

FIG. 7a shows two second slide members 20 fixedly mounted to the upper part of the C-shape, and two second slide members 20 fixedly mounted to the bottom part of the C-shape. The second slide members 20 are arranged in pairs, such that an upper second slide member 20 and a lower second slide member 20 are aligned in a vertical direction. The second slide members 20 are thus stationary relative to the fixed frame structure when the first guiding rail 210 is mounted to the fixed frame structure, i.e. they are statically arranged.

Further, the second slide members 20 each comprise a plurality of blades 221, each blade 221 corresponding to the blade 21 as described with reference to FIG. 1 herein. The second slide members 20 are made of a second plastic according to the principles described hereinbefore, such as POM. For example, the second slide members 20 could be formed by injection moulding a second plastic material.

FIG. 7c shows a first slide member 10 of the slide system 1. The first slide member 10 in this embodiment is an intermediate guiding rail in the form of an intermediate slide bar 130. The intermediate slide bar 130 is configured as a C-shape and has an upper and outer slide surface 132, an upper and inner slide surface 134, a bottom and inner slide surface 136, and a bottom and outer slide surface 138, as best shown in FIG. 7d. These slide surfaces 132, 134, 136, 138 are preferably planar, and the width of the outer slide surfaces 132, 138 is dimensioned to engage with the second slide members 20 of the first guiding rail 210. The slide surfaces 132, 134, 136, 138 may be formed according to the principles described hereinbefore, similar to the slide surface 14, and are provided with a lipophilic composition coating 18 to form respective slide layers 19 which may be similar to the slide layer 19 described hereinbefore with reference to FIG. 1 and the related description. For example, the intermediate slide bar 130 could be formed by extruding a first plastic, such as PA (e.g. PA6), that is different from the second plastic of the second slide members 20.

The Intermediate slide bar 130 is thus configured to be received by the C-shaped first guiding rail 210. The sliding system 1 also comprises a second guiding rail 140 to be fixedly mounted to a moveable part, e.g. the drawer extractable from the drawer frame. The second guiding rail 140 is provided with means (not shown), such as screw holes or similar, for attaching the second guiding rail 140 to the moveable part, i.e. the drawer.

FIG. 7e illustrates a cross-sectional view of the slide system 1 according to one embodiment in an assembled state. As can be seen in FIG. 7e, the second guiding rail 140 is L-shaped, whereby a lower part 142 can be used for aligning with the bottom end of the moveable part. Hence, the drawer may rest on the lower part 142, while the side wall of the drawer is screwed to a vertical part 144 of the second guiding rail 140.

The second guiding rail 140 is provided with one or more third slide members 150 protruding outwards for engagement with the inner slide surfaces 134, 136 of the intermediate slide bar 130. A plurality of separate third slide members 150 may be attached to the vertical part 144 of each second guiding rail 140. The vertical height of the third slide members 150 thus corresponds to the distance between the two inner slide surfaces 134, 136 of the intermediate slide bar 130. The third slide members 150 may be made of a third plastic being different from the first plastic according to the principles described hereinbefore. For example, the third slide members 150 may be formed by injection moulding a third plastic, such as POM, that is different from that of the intermediate slide bar 130. The third plastic may be the same type of plastic as the second plastic, such as POM.

In the slide system 1 shown in FIG. 7a, two sliding interfaces are provided, the first one being realized by the sliding engagement between the second slide members 20 of the first guiding rail 210 and the outer slide surfaces 132, 138 of the intermediate slide bar 130. The second sliding interface is realized by the sliding engagement between the inner slide surfaces 134, 136 of the intermediate slide bar 130 and the third slide members 150 of the second guiding rail 140. The sliding interfaces may include protrusions, e.g., blades, and grooves according to principles described hereinabove, see for example FIG. 1. For instance, in FIG. 7e, the third slide member 150 is provided with blades 151 in contact with the inner slide surfaces 134, 136 of the first slide member 10 being an intermediate slide bar 130. Hence, the inner slide surfaces 134, 136 and the outer slide surfaces 132, 138 of the first slide member 10 are preferably provided with a lipophilic composition coating 18 to form respective slide layers 19. The lipophilic composition coating 18 and the slide layers 19 are not shown in FIGS. 6a-6e. Optionally, the slide surfaces 132, 134, 136, 138 may further comprise a groove or track according to principles described hereinabove, see for example FIG. 1, adapted to receive the blades 121, 151 provided on the second and third slide members 20, 150. The first slide member 10 and the second slide member 20 are formed from different plastics, as described hereinabove. Further, the first slide member 10 and the third slide member 150 are formed from different plastics, as described hereinabove.

Thus, FIGS. 7a-7e show a slide system 1 comprising a first slide member 10 having at least two slide surfaces 132, 134, 136, 138 at least partly coated with a lipophilic composition coating 18 to provide at least two slide layers 19 with lowered friction; and a second slide member 20 arranged in sliding contact with the slide layer 19 at an interface and a third slide member 150 arranged in sliding contact with the slide layer 19 at an interface to provide a slide system 1. The interfaces between the slide layers 19 and the second slide member 20 and the third slide member 150 respectively form plain bearings to allow for sliding movement of the second slide member 20 and the first slide member 10 relative to each other, and the third slide member 150 and the first slide member 10 relative to each other. At least the slide surfaces 132, 134, 136, 138 of the first slide member 10 are made of a first plastic, such as PA (e.g. PA6), and at least a part of said second slide member 20 being in sliding contact with the slide layers 19 is made of a second plastic, such as POM, the first and the second plastics being different plastics. At least a part of said third slide member 150 being in sliding contact with the slide layer 19 is made of a third plastic, such as POM, the first and the third plastics being different plastics. Further, the second and the third plastics may be the same type of plastic.

While the embodiment of FIGS. 7a to 7e is described as a drawer sliding system 1 it will be appreciated that the slide system 1 presented in FIGS. 7a to 7e according to the described principles may be useful also in other applications, in particular applications where a moveable part is to be drawn out from a fixed part, including e.g. extendable tables, extendable sofas or extendable tables, etc.

Compared to metal slide members, which are hard and stiff and which may accept heavy loads while providing lowered friction, the plastic slide members 10, 20 of the present invention are easier and cheaper to manufacture. Plastic can be injection moulded or formed through extrusion in one piece, which are both simple and cheap processes. Elongated parts with uniform cross-section along its longitudinal extension, such as for instance the first slide member when being a slide bar, can advantageously be manufactured efficiently with extrusion. This process is fast, and can produce first slide members of varying lengths easily and cheaply. The second slide member, even if designed with details, can be manufactured by means of injection moulding in high volumes efficiently, with little waste material and with high precision. In addition, the need of surface treatment, washing and providing a lacquer on top of a metal slide member (as disclosed in e.g. WO 2017/044032) may be dispensed with. In the present invention, the first slide member 10 and the second slide member 20 are typically non-lacquered; or at least have a non-lacquered surface at the position where the first and second slide members 10, 20 are configured to come into contact with each other, forming the sliding contact between them.

To facilitate the application of the lipophilic composition onto the first slide member 10, the lipophilic composition can be applied to the second slide member 20, and subsequently be transferred, at least partly, to the first slide member 10 when the first and second slide members 10, 20 are brought into contact with each other.

The plastic slide members 10, 20 are also suitable for somewhat lighter applications than for instance metal slide members, which may be heavy and rigid. The present slide system 1 may thus preferably be used for sliding drawers, lighter sliding doors and the like.

Another benefit of using plastic slide members is that while metals are non-flexible, plastics are more flexible, thus enabling for instance the second slide member 20 to be snap-fitted into connection with the first slide member 10 in narrow, tight spaces.

Further, as shown in FIGS. 1 to 5, and 7a-e, the part of the second slide member 20 arranged in contact with the slide layer 19 may be configured as a blade 21 extending in the sliding direction. It was surprisingly found that decreasing the contact area at the interface between the first slide member 10 and the second slide member 20 reduced the friction. Normally the risk for the bearing seizing typically increases with reduced contact area. In order to provide the slide system 1, the second slide member 20 comprises at least one contact point in contact with the first slide member 10 at the interface between the slide surface 19 and the second slide member 20. According to an embodiment, the contact area of each individual contact point is less than 3 mm², such as less than 1.5 mm², or less than 0.75 mm². The slide system 1 may further be provided with more than one contact point, such as 2, 3, or 4 contact points. If, for example, the second slide member 20 is provided with a blade 21 extending in the sliding direction, then the edge of the blade 21 represents an individual contact point.

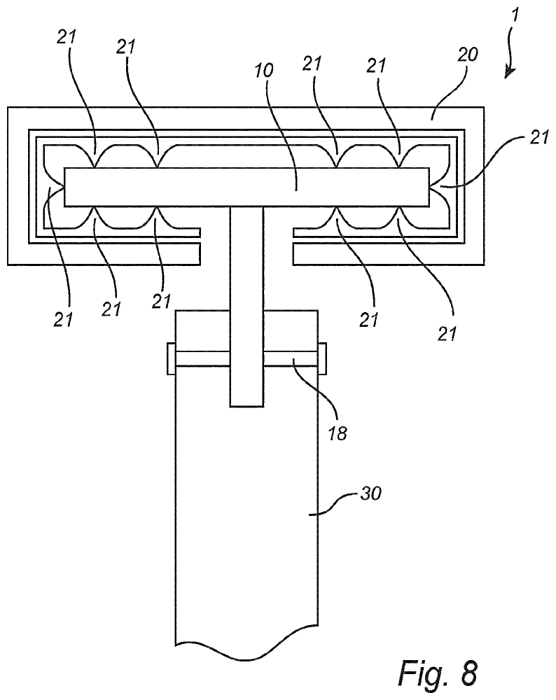

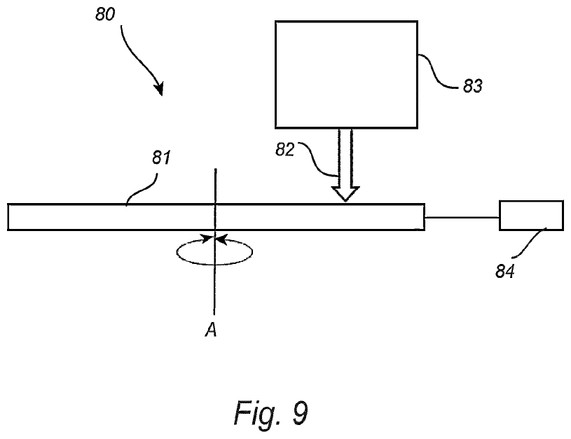

Alternatively, as shown in FIG. 8 and as opposed to some of the earlier embodiments described herein, the first slide member 10 is dynamically arranged whereas the second slide member 20 is statically arranged. Similar to what already has been described, the second slide member 20 may be provided with blades 21.

As shown in FIG. 8, the first slide member 10 adapted to slide along the second slide member 20 is a slide member in the form of a block having a flat surface in contact with the blades 21 arranged on the second slide member 20. The second slide member 20 encloses the first slide member 10 on its upper surface, its side surfaces and parts of its lower surface.

The first slide member 10 is provided with fastening arrangements 18, e.g. holes, pins, etc., for connecting the first slide member 10 further to a furniture part, such as a sliding door 30. Further, the first slide member 10 may, in an alternative embodiment, be provided with grooves or tracks 11 along which each blade 21 slides along a slide direction.

As described above, the plastic slide members 10, 20 of the present slide system 1 are cheaper and easier to manufacture than for instance slide members made of metal. Further, as described above, the slide system 1 of the present invention is particularly suitable for lighter furniture applications. It has been found that the friction becomes lower when the contact pressure between the second slide member and the first slide member is relatively high. The contact pressure is calculated by dividing the load carried by each individual contact point by the contact area of the contact point. For example, if a sliding door has a total weight of 8.5 kg this represents a total load of 83.3 N. If this sliding door of 8.5 kg, meaning a load of 83.3 N, is carried by two second slide members, and each such second slide member has four individual contact points having a contact surface, between such contact point and the first slide member, of 0.675 mm², the contact pressure is then calculated as: 83.3 N/(2 slide members×4 contact points×0.675 mm²)=15.4 N/mm². Preferably, the contact pressure in said at least one contact point is at least 4 N/mm², more preferably at least 8 N/mm², such as at least 12 N/mm². Preferably, the contact pressure is lower than the strain at yield (=yield strength) for the plastic material from which the second slide member 20 is made.

### EXAMPLES

The following examples are mere examples and should by no means be interpreted to limit the scope of the invention, as the invention is limited only by the accompanying claims.

### General

The test procedure used was based on a set up 80 schematically shown in FIG. 8. A circular disc of plastic 81 is provided, along with two plastic tips 82, each tip 82 having a length, as seen in the direction of travel, of 3 mm, a radius at its outer end of 0.2 mm and being a tip with a pointed angle of 60 degrees. The tips are arranged in contact with a groove on the disc 81. However, in the schematic set up 80 of FIG. 8, only one tip 82 is shown. The tips 82 used during testing were formed from POM.

Said groove of the disc 81 is imagined to correspond to the groove 11 present in the slide system 1 of the present invention, while the tip 82 is imagined to correspond to the blade 21 present in the slide system 1 of the present invention. The groove is coated with the lipophilic composition coating 18 to provide a slide layer 19 having lowered friction. Thereby, the principle during testing with the set-up 80 will be the same as illustrated in the upper right enlargement of FIG. 1.

A weight 83 is arranged on top of the tips 82 to exert a load thereon. During these experiments, the weight 83 mounted to 15 kg, divided equally onto the two tips 82. Once the load 83 of 15 kg is applied to the two tips 82, the plastic disc 81 is rotated/moved with a reciprocating circular movement in a clockwise or counterclockwise direction around a rotational axis A, indicated by the double ended rounded arrow in FIG. 8.

The circular disc 81 is mounted on a support connected to a motor 84 turning the disc 81 clockwise and counterclockwise, while the tips 82 are static. The frictional force F is measured against the rotation. The energy input to the motor 84 needed for reciprocating the disc 81 is a measure of the frictional force F that the motor 84 has to overcome to rotate the disc 81, being in contact with the two tips 82.

Each test included 50 000 cycles to verify the satisfying results. Each such cycle including turning the disc almost a complete round and then turning it back to its starting position. If unsatisfying results were obtained already early in the test process, e.g. after 10 000 cycles, the experiment was terminated since the material selections were not considered to fulfil the resistance requirements. The test results are disclosed below in the Examples.

### Example 1—Positive Control

Before the tests using the test set up using plastic materials as described with reference to FIG. 8, a first test was conducted using a disc of metal and a lipophilic lubricating coating 18 to obtain a positive control value of frictional force. The metal disc was, prior to applying the lubricating coating 18, electrophoretically coated with a lacquer pursuant to the principles described in WO2017/044032A1. The test results for Example 1 are shown below in Table 1. The test results show that after an initial resistance force caused by friction of approximately 3.5 N, the frictional force was kept constant at around 3 N.

TABLE 1
the resistance measured in N for testing using tips of
POM and an electrophoretically lacquered disc of steel
metal, covered with a lipophilic composition coating.

| Cycle no. | Force (N) |
|---|---|
| 1 | 3.5 |
| 10 000 | 3 |
| 20 000 | 3 |
| 30 000 | 3 |
| 40 000 | 3 |
| 50 000 | 3 |

### Example 2—POM+POM

The test results for the testing setup as described above using tips of POM and a disc also formed from POM, and covered by a lipophilic composition, are presented below in Table 2. Already after a low number of cycles, the resistance increased up to 10 N. After approximately 1000 cycles the resistance was kept constant at these high forces. Hence, the testing was terminated after about 13 000 cycles. It could thus be concluded that the use of two plastic slide members of the same plastic is less preferable.

TABLE 2
the resistance measured in N for testing using tips of POM and
a disc of POM, covered with a lipophilic composition coating.

| Cycle no. | Force (N) |
|---|---|
| 1 | 4 |
| 1 000 | 9 |
| 2 000 | 9-10 |
| 3 000 | 9-10 |
| 4 000 | 9-10 |
| 5 000 | 9-10 |
| 10 000 | 9-10 |

### Example 3—POM+PA6

The test results for the testing setup as described above using tips of POM and a disc formed from PA6 are presented below in Table 3. From the first cycle to the last, this combination of plastic materials depicted an even and low resistance. The initial dynamic resistance was lower than in Example 2. Since the same lipophilic composition coating was used as in Example 2, the selection of the plastic materials seemingly influences the resistance between the slide members, both initially and especially in the long run. The value of 3.5 N is also matching the measurements obtained for the positive control (Example 1).

TABLE 3
the resistance measured in N for testing using tips of POM and
a disc of PA6, covered with a lipophilic composition coating.

| Cycle no. | Force (N) |
|---|---|
| 1 | 3.5 |
| 10 000 | 3.5 |
| 20 000 | 3.5 |
| 30 000 | 3.5 |
| 40 000 | 3.5 |
| 50 000 | 3.5 |

### Example 4—POM+PA6 (No Lipophilic Composition Coating)

The test using POM and PA6 was also conducted without the use of the lipophilic composition coating. The initial dynamic friction was significantly higher. Further, test results show that the friction without the lipophilic composition coating present rapidly, i.e. within only a few hundred cycles (compared to the 50 000 rounds performed in Example 2), escalated to as high as about 14-15 N. The test results of Example 4 are shown below in Table 4. The test was terminated after only 250 cycles.

TABLE 4
the resistance measured in N for testing using POM and PA6,
without any lipophilic composition coating present.

| Cycle no. | Force (N) |
|---|---|
| 1 | 10.5 |
| 50 | 10 |
| 100 | 10.5 |
| 200 | 12 |
| 250 | 14 |

### Example 5—POM+PC

The test results for the testing setup as described above using tips of POM and a disc formed from PC are presented below in Table 5. Similarly to Example 3, from the first cycle to the last, this combination of plastic materials depicted a fairly even and low resistance, with a maximum value of 5 N. As for Example 3, we can conclude that since the same lipophilic composition coating was used as in Example 2, the selection of the plastic materials seemingly influencing the resistance between the slide members, both initially and in the long run. The maximum value of 5 N is considered acceptable and satisfying, as for instance compared to the values of e.g. 10 and 14 N exhibited in Examples 2 and 4, respectively.

TABLE 5
the resistance measured in N for testing using tips of POM and
a disc of PC, covered with a lipophilic composition coating.

| Cycle no. | Force (N) |
|---|---|
| 1 | 4.5 |
| 10 000 | 4.5 |
| 20 000 | 4.5 |
| 30 000 | 5 |
| 40 000 | 5 |
| 50 000 | 5 |

### Example 6—POM+PMMA

The test results for the testing setup as described above using tips of POM and a disc formed from PMMA are presented below in Table 6. Similarly to Example 5, from the first cycle to the last, this combination of plastic materials depicted a fairly even and low resistance, with a maximum value of 6.5 N. As for Example 5, we can conclude that even though the initial frictional force (4.5 N) was slightly lower than the maximum force measured in the end of the experiment (6.5 N), the maximum value of 6.5 N is considered low enough to be a satisfying test result. This is in contrast to for instance the values of e.g. 10 and 14 N exhibited in Examples 2 and 4, respectively.

The combination of POM and PMMA hence provide a satisfying result both initially and in the long run.

TABLE 6
the resistance measured in N for testing using tips of POM and
a disc of PMMA, covered with a lipophilic composition coating.

| Cycle no. | Force (N) |
|---|---|
| 1 | 4.5 |
| 10 000 | 4.5 |
| 20 000 | 5 |
| 30 000 | 6 |
| 40 000 | 6 |
| 50 000 | 6.5 |

### Example 7—POM+PPCO

The test results for the testing setup as described above using tips of POM and a disc formed from PPCO are presented below in Table 7. As opposed to for instance the test in Example 6, from the first cycle to the last, this combination of plastic materials depicted a decreasingly lowered resistance, with a maximum initial frictional value of 6 N.

We can conclude that even though the initial frictional force (6 N) was slightly higher than the maximum values measured in Examples 3 and 5, the frictional force stabilized relatively quickly and dropped to as low as 3.5 N, which is as low as the result depicted in Example 3, and almost as low as for the positive control (3 N) described in Example 1. The combination of POM and PPCO hence provide a satisfying result both initially and in the long run.

TABLE 7
the resistance measured in N for testing using tips of POM and
a disc of PPCO, covered with a lipophilic composition coating.

| Cycle no. | Force (N) |
|---|---|
| 1 | 6 |
| 10 000 | 3.5 |
| 20 000 | 3.5 |
| 30 000 | 3.5 |
| 40 000 | 3.5 |
| 50 000 | 3.5 |

### CONCLUSION

From the Examples 1-7, we can conclude that using a first slide member and a second slide member made from the same plastic material (Example 2), such as POM, does not result in a satisfying lowering of the friction between the two slide members.

However, it has surprisingly been found that by using slide members of two different plastics, such as POM and PA6, the friction can be decreased significantly. Without being bound by any theory, this effect is thought to derive from that two parts of the same plastic material exhibit larger attraction forces against each other than two different plastic materials, resulting in a higher friction there between. Example 3 also indicate that there is a synergistic effect between the use of the lipophilic composition coating and plastic slide members formed of different plastic materials, such as POM and PA6. Seemingly, the degree of synergism differs between different combinations of plastic materials. The combination of POM and PA6 represents a preferred combination. Another advantageous combination between two different plastics is using slide members formed from PET and POM, which also benefits from the effects described above (data not shown).

### Example 8—PA6 or PET+POM

An experimental set-up in line with what is shown in FIGS. 6a-6b has been evaluated. In said experiment, the first slide member 10, being in the form of a U-shaped longitudinal first slide member 10 arranged in a recess 63 in a floor portion 61 and/or top portion 62, was made of PA6 or PET, and the second slide member 20, arranged as a sliding door 60, was made of POM. Low dynamic friction was provided by both of the two first slide members 10 (PA6 and PET, respectively). As already stated, combination of PA6/POM, as well as of PET/POM, represent preferred combinations.

Without further elaboration, it is believed that one skilled in the art may, using the preceding description, utilize the present invention to its fullest extent. The preceding preferred specific embodiments are, therefore, to be construed as merely illustrative and not limitative of the disclosure in any way whatsoever.

Although the present invention has been described above with reference to specific embodiments, it is not intended to be limited to the specific form set forth herein. Rather, the invention is limited only by the accompanying claims and other embodiments than those specifically described above are equally possible within the scope of these appended claims, e.g. different embodiments than those described above.

In the claims, the term “comprises/comprising” does not exclude the presence of other elements or steps. Additionally, although individual features may be included in different claims, these may possibly advantageously be combined, and the inclusion of two features in different claims does not imply that a combination of those features is not feasible and/or advantageous.

In addition, singular references do not exclude a plurality. The terms “a”, “an”, “first”, “second” etc. do not preclude a plurality.

1. A slide system comprising:
a first slide member having a slide surface at least partly coated with a lipophilic composition coating to provide a slide layer with lowered friction; and
a second slide member arranged in sliding contact with the slide layer at an interface to provide a slide system, wherein the interface between the slide layer and the second slide member forms a plain bearing to allow for sliding movement of the second slide member and the first slide member relative to each other;
wherein at least the slide surface of the first slide member is made of a first plastic, and wherein at least a part of said second slide member being in sliding contact with the slide layer is made of a second plastic, the first and the second plastics being different plastics.

2. The slide system according to claim 1, wherein the first plastic and/or the second plastic is a thermoplastic.

3. The slide system according to claim 1, wherein the first and the second plastics are polymers selected from the group of polymers consisting of polyoxymethylenes (POM), polymethyl methacrylate (PMMA), polycarbonate (PC), polypropylene (PP), polypropylene copolymers (PPCO), thermoplastic polyesters, polyamides (PA), polyvinyl chloride (PVC), polyphenylene sulfide (PPS), polyaryletherketone (PAEK), and Polytetrafluoroethylene (PTFE).

4. The slide system according to claim 3,
wherein the first slide member is made of polyamide (PA), polycarbonate (PC), polyethylene terephthalate (PET), polybutylene terephthalate (PBT), polypropylene copolymers (PPCO), or polymethyl methacrylate (PMMA); and wherein the second slide member is made of polyoxymethylene (POM) or polyamide (PA); or
wherein the second slide member is made of polyamide (PA), polycarbonate (PC), polyethylene terephthalate (PET), polybutylene terephthalate (PBT), polypropylene copolymers (PPCO), or polymethyl methacrylate (PMMA), and wherein the first slide member is made of polyoxymethylene (POM) or polyamide (PA),
wherein the first slide member and the second slide member are made of different plastics.

5. The slide system according to claim 4, wherein the first slide member is made of polyamide (PA) or polyethylene terephthalate (PET), and the second slide member is made of polyoxymethylene (POM).

6. The slide system according to claim 1, wherein the first slide member is a slide bar forming a linear slide profile, the slide bar being a plastic slide bar made of the first plastic.

7. The slide system according to claim 6, wherein the plastic slide bar forming the linear slide profile is provided with a plastic profile surface arranged on a support structure.

8. The slide system according to claim 6, wherein the plastic slide bar has the form of an insert to be arranged in a recess of the support structure.

9. The slide system according to claim 6, wherein plastic the slide bar is moulded.

10. The slide system according to claim 1, wherein the second slide member is moulded in one piece.

11. The slide system according to claim 1, wherein the slide surface of the first slide member is at least 150 μm thick.

12. The slide system according to claim 1, wherein the part of said second slide member being in contact with the slide layer of the slide surface is configured as at least one blade extending in a sliding direction.

13. The slide system according to claim 1, wherein the slide layer is present at a track, extending along a sliding direction.

14. The slide system according to claim 12, wherein the second slide member comprises at least one individual contact point, in the form of the at least one blade, in contact with the first slide member at the interface between the first slide member and the second slide member, the contact area of each individual contact point being less than 3 mm².

15. The slide system according to claim 1, wherein the first slide member and the second slide member of the slide system are provided in a sliding application of a furniture in which the slide system is carrying a load of less than 35 kg.

16. The slide system according to claim 1, wherein the first slide member and the second slide member of the slide system are provided in an extendable table sliding system, a drawer sliding system, a sliding door system, a sofa bed, or a furniture rotary system.

17. The slide system according to claim 1, wherein the lipophilic composition coating comprises compounds comprising C6 to C40 non-aromatic hydrocarbyl groups.

18. The slide system according to claim 17, wherein the lipophilic composition coating comprises at least 25 wt. % of compounds comprising C6 to C40 alkyl groups, and/or wherein the lipophilic composition coating comprises at least 25 wt. % C6 to C40, non-aromatic hydrocarbons.

19. The slide system according to claim 18, wherein the lipophilic composition comprises triglycerides and/or fatty acids.

20. A method for providing a slide system according to claim 1, comprising the steps of:
providing a member having a slide surface, wherein at least the slide surface is made of a first plastic;
coating at least part of the slide surface with a lipophilic composition coating to provide a first slide member having a slide layer with lowered friction;
providing a second slide member, wherein at least a part of said second slide member configured to be in sliding contact with the slide layer is made of a second plastic, the first and the second plastics being different plastics; and
arranging the first slide member and the second slide member such that an interface between the slide layer and the second slide member forms a plain bearing to allow for sliding movement of the second slide member and the first slide member relative to each other.
